(19) United States
(12) Patent Application Publication
(10) Pub. No.: US 2020/0009977 A1
(43) Pub. Date: Jan. 9, 2020

(54) CHARGING ROBOT AND PARKING SYSTEM

(71) Applicant: LG ELECTRONICS INC., Seoul (KR)

(72) Inventor: Jong Hun PARK, Seoul (KR)

(73) Assignee: LG ELECTRONICS INC., Seoul (KR)

(21) Appl. No.: 16/571,432

(22) Filed: Sep. 16, 2019

(30) Foreign Application Priority Data
Jun. 12, 2019 (KR) PCT/KR2019/007096

(51) Int. Cl. B60L 53/35; B60L 53/60; B60L 53/30; B25J 9/16

(52) U.S. Cl. CPC B60L 53/35; B60L 53/60; B60L 53/31; B25J 9/1694; B60L 53/305

(57) ABSTRACT

Disclosed is a parking system in which a charging robot is located in a charging housing area. The parking system may include a communicator for communicating with the charging robot, an input unit for inputting a user input or an image signal, one or more sensors, a transportation unit for driving a parking plate to move the EV to an area in which the charging robot is disposed, and a controller for determining, based on information sensed by the sensor or information inputted through the input unit, whether an entering vehicle is an EV to be charged by the charging robot. Accordingly, a charging robot and charging system having artificial intelligence and performing 5G communication can be provided.

### CROSS-REFERENCE TO RELATED APPLICATION

This present application claims benefit of priority to PCT Patent Application No. PCT/KR2019/007096, entitled “Charging robot and parking system,” filed on Jun. 12, 2019, in the World Intellectual Property Organization, the entire disclosure of which is incorporated herein by reference.

### BACKGROUND

### 1. Field of the Invention

The present disclosure relates to a charging robot for charging an electric vehicle battery in a parking space, a parking system for managing the parking space, and a driving method therefor.

### 2. Description of Related Art

In recent years, there has been a growing demand for more environmentally friendly vehicles due to global warming, depletion of fossil fuels, and the like. Accordingly, automobile manufacturers in each country are developing and producing electric vehicles (hereinafter referred to as “EVs”) that provide better driving conditions and are also economically advantageous, without emitting air pollutants such as carbon dioxide, sulfur dioxide, and the like during driving.

An EV is a car that uses a battery and an electric motor, which is driven by rotating the electric motor using energy stored in the battery and charges the battery by using internal or external power sources. Since the EV driven by the battery needs to charge the battery frequently, EV charging stations are being installed and operated.

In addition, as the number of vehicles increases sharply, mechanical parking towers, in which a large number of vehicles may be simultaneously parked in a relatively narrow space, are increasingly being installed.

Korean Patent Application Publication No. 10-2012-0113084, entitled “System for electric car charging” discloses a system for electric car charging including a plurality of chargers for charging a plurality of EV batteries, wherein the charger charges an electric car based on a power amount of an external power source and of a power buffer unit storing backup power.

However, the above-mentioned system does not consider charging the EV battery in the parking tower, nor does it perform charging using a charging robot.

Korean Patent Application Publication No. 10-2018-0115191, entitled “Electric vehicle charging apparatus for parking tower” discloses an electric vehicle charging apparatus for a parking tower, which includes a charger, a transportation unit, a coupler of the charger, and a charger transferring unit, wherein when the electric car is parked in the parking tower, the charger moves up and down to charge the battery of the electric vehicle.

However, since the above-mentioned charging apparatus has to be disposed on a separate structure, it is difficult to apply the charging apparatus to existing parking towers.

### SUMMARY OF THE INVENTION

The present disclosure is directed to providing a charging robot and a parking system that can charge an EV battery by remodeling only a predetermined area of an existing parking tower.

The present disclosure is further directed to providing a parking system that can quickly perform charging by providing the charging robot with information on a vehicle entering a parking tower.

The present disclosure is still further directed to providing an efficient parking system for moving an EV of which charging is completed to a suitable parking area within the parking tower for parking.

The present disclosure is still further directed to providing a charging robot and a parking system that can charge the EV battery in various parking spaces as well as the parking tower.

The present disclosure is not limited to what has been mentioned above. A person skilled in the art may clearly understand, from the following description, other aspects not mentioned.

A parking system according to one embodiment of the present disclosure may provide, within a parking tower or other parking space, a charging housing area in which an EV may be charged, and dispose a charging robot in the charging housing area.

The charging robot may include: a communication unit configured to communicate with a parking system; a robot arm configured to handle a charging gun connected to an EV charging source; an input unit configured to input an image signal; and a control module configured to recognize a charging port of an EV based on information inputted through the input unit, and control the robot arm such that the robot arm couples the charging gun to the charging port or decouples the charging gun from the charging port.

The parking system may transmit, through the communication unit, position information on the charging port of an EV to be charged and desired amount-of-charge information on the EV, to the charging robot.

The parking system may include: a communication unit configured to communicate with a charging robot; an input unit configured to input a user input or an image signal; one or more sensing units; a transportation unit configured to drive a parking plate to move the EV to an area in which the charging robot is disposed; and a control module configured to determine, based on information sensed by the sensing unit or information inputted through the input unit, whether an entering vehicle is an EV to be charged by the charging robot.

A driving method of a parking system having a charging housing area in which an EV may be charged, according to one embodiment of the present disclosure, may include the steps of: when a vehicle enters, determining whether the entering vehicle is an EV to be charged; checking whether the charging housing area is available when desired amount-of-charge information on the entering vehicle is inputted; and moving the entering vehicle to the charging housing area using a rotatably and vertically drivable parking plate when the charging housing area is available.

The driving method may further include the steps of: moving the entering vehicle to a predetermined housing area adjacent to the charging housing area when the charging housing area is in use; and adding information on the entering vehicle to an EV charging waiting list.

The driving method may further include determining whether to move the entering vehicle, based on estimated charge completion time information on the EV being charged and based on information on whether a subsequent vehicle is present, when the charging housing area is in use.

The driving method may further include moving, to the charging housing area, an EV having a higher priority on the EV charging waiting list, when the charging housing area becomes available.

The moving the entering vehicle to the charging housing area using the parking plate may include: rotating the parking plate so that the charging robot grasping the charging gun located at the EV charging source may easily move to the position of the charging port of the entering vehicle; and vertically raising the entering vehicle with the rotated parking plate so as to park the entering vehicle in the charging housing area.

The technical solution of the present disclosure is not limited to those mentioned above. A person skilled in the art may clearly understand from the following description, other technical solutions not mentioned.

According to various embodiments of the present disclosure, the following effects are able to be obtained.

First, since only a predetermined area of an existing parking space is remodeled without the need of installing additional charging facilities, the applicability to the existing parking space can be facilitated, the space can be efficiently utilized, and installation costs can be reduced.

Second, an EV to be charged is moved to a suitable parking place within a parking tower, and charging and parking of the moved EV are accomplished at the same time, thereby improving charging and parking efficiency.

### BRIEF DESCRIPTION OF DRAWINGS

FIG. 1 is a block diagram illustrating a configuration of a charging robot for charging an EV battery in a parking tower, according to one embodiment of the present disclosure.

FIG. 2 is a view illustrating a situation in which the charging robot charges the EV battery in the parking tower, according to one embodiment of the present disclosure.

FIG. 3 is a view illustrating the charging robot for charging the EV battery in a charging housing area within the parking tower, according to one embodiment of the present disclosure.

FIG. 4 is a view illustrating a user interface in which a parking system receives necessary information and provides the necessary information to an EV charging user, according to one embodiment of the present disclosure.

FIG. 5 is a block diagram illustrating a configuration of the parking system according to one embodiment of the present disclosure.

FIG. 6 is a system diagram illustrating a communication method among components including the parking system and the charging robot, according to one embodiment of the present disclosure.

FIG. 7 is a sequence diagram illustrating operations of the parking system for managing the parking tower, according to one embodiment of the present disclosure.

FIG. 8 is a sequence diagram illustrating operations of the charging robot for charging the EV battery, according to one embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Hereinafter, the embodiments disclosed in this specification will be described in detail with reference to the accompanying drawings. In the following description and drawings, the same reference numbers refer to the same components. Only the differences with respect to individual embodiments are described. In the following description of the embodiments disclosed in this specification, detailed description of related known technology will be omitted when it may obscure the subject matter of the embodiments according to the present disclosure.

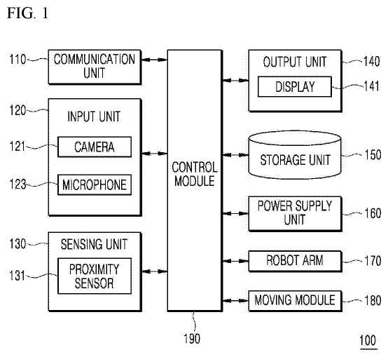

FIG. 1 is a block diagram illustrating a configuration of a charging robot 100 for charging an EV battery in one area of a parking tower, according to one embodiment of the present disclosure. The parking tower includes a plurality of housing areas in which a vehicle may be parked.

Referring to FIG. 1, the charging robot 100 may include: a communication unit 110; an input unit 120; a sensing unit 130; an output unit 140; a storage unit 150; a power supply unit 160; a robot arm 170; a moving module 180; a control module 190, and the like. The components shown in FIG. 1 are not essential for implementing the charging robot 100, and thus the charging robot 100 described in this specification may have fewer or more components than those listed above.

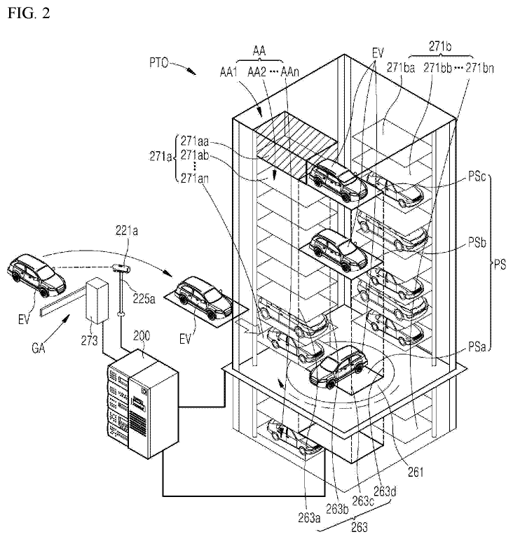

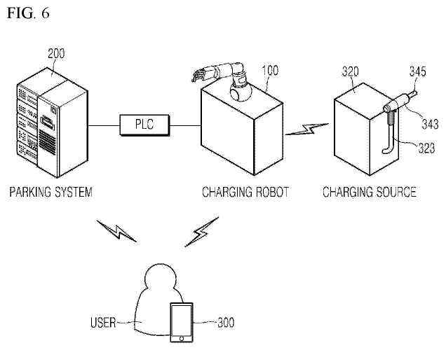

More specifically, the communication unit 110 of the above components may include one or more wired or wireless communication modules that enable communication between the charging robot 100 and a parking system (200 in FIG. 2), between the charging robot 100 and a mobile terminal (300 in FIG. 6), and between the charging robot 100 and a device having a communication module. The communication unit 110 may include a mobile communication module, a local area communication module, and the like. In some implementations, communication unit 110 may be implemented communicator. In some implementations, communication unit 110 comprises at least one of communicator or consists of at least one of communicator.

The mobile communication module transmits and receives a radio signal to and from at least one of a base station, an external terminal, a server, and the like on a mobile communication network established according to technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and the like) and 5G (Generation) communication systems.

The input unit 120 may include: a camera 121 or image input unit from which the input unit 120 receives an image signal; a microphone 123 or audio input unit from which the input unit 120 receives an audio signal; a user input unit such as a touch key or a mechanical key for receiving information from a user; and the like. Audio data or image data collected by the input unit 120 may be analyzed and processed as a user's control instructions. In some implementations, input unit 120 may be implemented inputter or input interface. In some implementations, input unit 120 comprises at least one of inputter or consists of at least one of inputter. In some implementations, input unit 120 may be configured to input data and signals.

The sensing unit 130 may include one or more sensors for detecting at least one of information related to the charging robot 100 itself, information on the surrounding environment of the charging robot 100, and user information. For example, the sensing unit 130 may include at least one of: a proximity sensor 131; an illumination sensor; a touch sensor; an acceleration sensor; a magnetic sensor; a G-sensor; a gyroscope sensor; a motion sensor; an RGB sensor; an infrared sensor (IR sensor); a finger scan sensor; an ultrasonic sensor; an optical sensor (see, for example, camera 121); a microphone (see microphone 123); a weight sensing sensor; a battery gauge; an environment sensor such as a barometer, a hygrometer, a thermometer, a radiation sensing sensor, a heat sensing sensor, and a gas sensing sensor; and a chemical sensor such as an electronic nose, a healthcare sensor, and a biometric sensor. In addition, the charging robot 100 disclosed in this specification may combine and utilize information detected by at least two of the above-mentioned sensors. The sensing unit 130 comprises at least one of a sensor.

The output unit 140 is for generating a visual output, an audio output, a tactile output, and the like, and may include at least one of a display 141 (a plurality of displays also being applicable), one or more light emitting devices, a voice output unit, and a haptic module. The display 141 may be formed to be layered with the touch sensor or may be formed to be integrated with the touch sensor, so that the display 141 may be implemented as a touch screen. The touch screen may function as a user input unit for providing an input interface between the charging robot 100 and a user, and at the same time may provide an output interface between the charging robot 100 and the user.

The storage unit 150 stores data which enables the charging robot 100 to perform various functions. The storage unit 150 may store a number of application programs (or applications) running on the charging robot 100, data for operation of the charging robot 100, instructions. At least some of these application programs may be downloaded from an external server through wireless communication.

Under the control of the control module 190, the power supply unit 160 is powered internally and/or externally, and supplies power to each component of the charging robot 100. The power supply unit 160 includes a battery, which may be a built-in battery or a replaceable battery. The battery may be charged by a wired or wireless charging scheme, wherein the wireless charging scheme may include a magnetic induction scheme or a magnetic resonance scheme.

When the battery level of the power supply unit 160 is insufficient to carry out a moving operation, the control module 190 may cause the charging robot 100 to move to a predetermined charging place in order to charge the battery. That is, the charging robot 100 may charge the EV battery, and may move to the predetermined charging place when the battery of the charging robot 100 needs to be charged. The predetermined charging place may be a charging housing area. Accordingly, abrupt stoppage or malfunction of the charging robot 100 can be prevented.

The charging robot 100 may include at least one robot arm 170 capable of grasping a charging gun connected to an EV charging source. Under the control of the control module 190, the robot arm 170 may decouple the charging gun from a holder of the charging gun and couple the charging gun to a charging port of the EV. When charging is completed, the robot arm 170 may decouple the charging gun from the charging port of the EV and then return the charging gun to the holder of the charging gun. In such a case, a manner in which the charging gun is coupled to and decoupled from the charging port of the EV may vary. The robot arm 170 may use an image photographed from the camera 121 to perform the coupling and the decoupling between the charging gun and the charging port.

The moving module 180 is a module that is capable of moving the charging robot 100. More specifically, the moving module 180 may be a module that is capable of moving directly by its own wheels, or that allows the charging robot 100 to move along a rail when the charging robot 100 is placed on the rail. The moving module 180 comprises at least one of a mover or consists of at least one of a mover.

The control module 190 may recognize the charging port of the EV based on information detected by the sensing unit 130 or information inputted through the camera 121, and may control the robot arm 170 such that the robot arm 170 couples the charging gun to the charging port or decouples the charging gun from the charging port. In some implementations, the control module may be implemented a controller. In some implementations, the control module 190 comprises at least one of a controller.

The control module 190 may transmit charge status information on the EV to the parking system (200 in FIG. 2) through the communication unit 110 in real time, and may receive the charge status information from the EV through the communication unit 110. When charging of the EV is completed, the control module 190 may transmit charge completion information on the EV to the parking system 200 through the communication unit 110. In addition, the control module 190 may receive position information on the charging port of the EV and desired amount-of-charging information on the EV from the parking system 200 through the communication unit 110.

According to one embodiment, the control module 190 may receive a charge completion message on the EV from the EV charging source or the charging gun.

In addition, the charging robot 100 may be disposed in a single-level or multi-level parking space as well as the parking tower.

Hereinafter, a situation in which the charging robot 100 charges the EV battery in a parking tower PTO according to one embodiment of the present disclosure will be described with reference to FIG. 2.

The parking tower PTO is a mechanical parking tower in which a plurality of housing areas may be provided in a vertical space within a building, and a plurality of vehicles may be parked in the plurality of housing areas. In such a case, each of the plurality of housing areas is fixed, and the vehicle may be moved to a predetermined housing area by a transportation unit for moving the vehicle. However, depending on the embodiment, each of the plurality of housing areas may be implemented in a rotatable manner. In such a case, the charge housing area may be installed on the ground.

A gate GA is a place in which the EV enters and exits, and may include an entry and exit gate 273 and a first camera 221a. The first camera 221a may be fixed to a pole 225a. The entry and exit gate 273 may perform, under the control of the parking system 200, an open/close operation so that the EV is able to enter and exit. The parking system 200 may recognize a vehicle model of the EV, a vehicle name of the EV, the position of the charging port of the EV, and the like, from an image photographed through the first camera 221a. That is, the parking system 200 may recognize whether the vehicle entering the gate GA is the EV, the position of the charging port, and the like, and may provide the charging robot 100 with information related thereto.

In such a case, the parking system 200 may transmit various data to the charging robot 100 and other devices through a wired communication method such as Power Line Communication (PLC), or alternatively through a wireless communication method.

The parking system 200 may allow entry of all vehicles if there is an available housing area. However, depending on the embodiment, the parking system 200 may control the entry and exit gate 273 such that only entry of registered vehicles is allowed, and entry of vehicles that use gasoline, diesel fuel, and the like, as a power source is not allowed.

In addition, the parking system 200 may present a discount of a charging fee or issue various coupons to predetermined members, and the coupons may be provided in the form of a push notification to the mobile terminal (300 in FIG. 6) of the EV occupant, but the embodiment is not limited thereto.

The parking system 200 is a system for managing vehicles parked in the parking tower PTO, and the parking tower PTO may include a plurality of housing areas AA and AA1 to AAn. The plurality of housing areas AA and AA1 to AAn may include parking surfaces 271a and 271b on which the vehicles are parked. The plurality of housing areas AA and AA1 to AAn may include a charging housing area AA1 in which the charging robot 100 is disposed to charge the EV battery.

In addition, the parking system 200 includes a transportation unit (260 in FIG. 5), and the transportation unit 260 may include: a rotational movement unit 261 that rotates a parking plate PS; a vertical movement unit 263 for vertically raising and lowering the parking plate PS; and a horizontal movement unit (not shown, 265 in FIG. 5) for moving the parking plate PS horizontally. In such a case, the rotational movement unit 261 may turn the parking plate PS to set the parking direction of the vehicle, and the parking plate PS may become a parking surface when entering the housing area, but may also be implemented separately from the parking surface depending on the embodiment. The transportation unit 260 comprises at least one of a transporter or consists of at least one of a transporter. The vertical movement unit 263 comprises at least one of a vertical mover or consists of at least one of a vertical mover. The rotational movement unit 261 comprises at least one of a rotational mover or consists of at least one of a rotational mover. The horizontal movement unit comprises at least one of a horizontal mover or consists of at least one of a horizontal mover or consists of at least one of a horizontal mover.

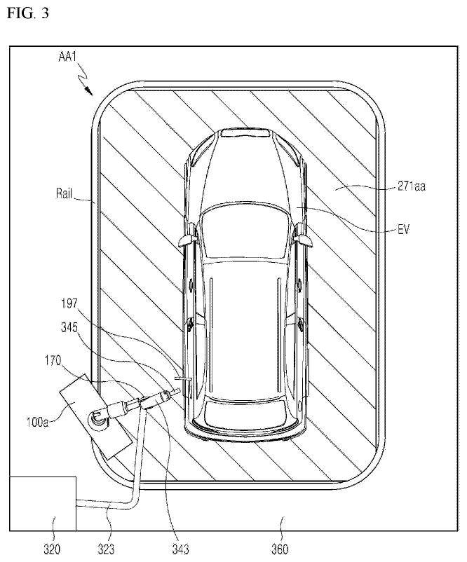

Here, the charging housing area AA1 may be disposed at the top floor of the parking tower PTO, but may also be disposed at various positions of the parking tower PTO depending on the embodiment. A more specific structure of the charging housing area AA1 will now be described with reference to FIG. 3.

FIG. 3 is a view illustrating the charging robot 100 for charging the EV battery in the charging housing area AA1 of the parking tower PTO according to one embodiment of the present disclosure, and is also a view illustrating a structure of the charging housing area AA1.

The parking system 200 may first determine whether the entering vehicle passing through the gate GA is the EV to be charged, and may then cause the entering vehicle to move to the charging housing area AA when the entering vehicle is the EV to be charged.

Specifically, the parking system 200 may cause the EV to move to the charging housing area AA1 using the transportation unit (260 in FIG. 5). In such a case, in a charging housing area plate 360 may be disposed an EV charging source 320, a cable 323 connected to the EV charging source 320, and a charging gun 343 having an adapter 345, as well as a charging robot 100a having a robot arm 170a. In addition, a rail for moving the charging robot 100a may be disposed in the charging housing area plate 360.

The size of the charging housing area plate 360 may be larger than that of the parking surface 271aa. When the EV is not parked in the charging housing area AA1, the charging housing area plate 360 is held in the air above the parking surface 271aa within the charging housing area AA1. However, when the parking plate PS is placed on the parking surface 271aa by the transportation unit 260, the charging housing space plate 360 may be lowered to be placed in contact with the top of the parking surface 271aa. However, a manner in which the charge housing area plate 360 is implemented may vary depending on the embodiment. In such a case, the parking surface 271aa may be the same as the parking plate PS, but may also be implemented as a separate plate.

The charging robot 100a may couple the adapter 345 of the charging gun 343 to the charging port of the EV using the robot arm 170a. The charging robot 100a may instruct the EV charging source 320 to start the charging of the EV, and the EV charging source 320 may transmit a charge completion command to the charging robot 100a. The transmission may be performed by a wired communication method or a wireless communication method.

The charging robot 100a may receive, from the parking system 200, the position information on the charging port of the EV and the desired amount-of-charging information on the EV, and perform the charging based on the received information. Thus, the charging can be performed at high speed.

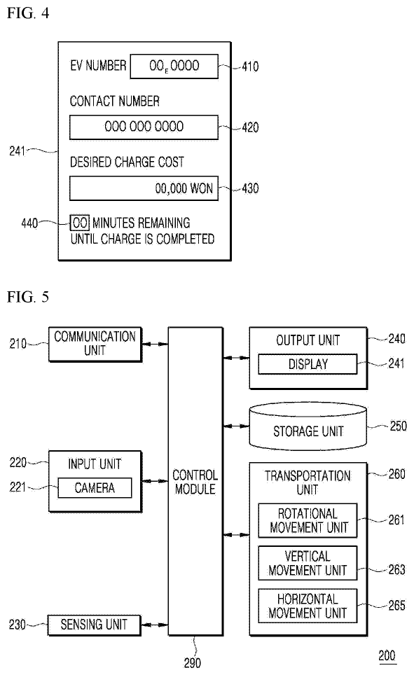

FIG. 4 illustrates a user interface in which the parking system 200 receives necessary information and provides the necessary information to the EV charging user, according to one embodiment of the present disclosure.

Referring to FIG. 4, the parking system 200 may receive a user input through a display 241. For example, the display 241 may receive, through a touch input of the user, vehicle number information 410, contact number information 420, desired charge cost information 430, and the like of the EV. In such a case, the parking system 200 may display, to the user through the display 241, waiting time information 440 about the time it will take for the charging to complete. However, depending on the embodiment, the parking system 200 may input or display more information than that shown in FIG. 4.

According to one embodiment, the parking system 200 may also collect the information shown in FIG. 4 from a mobile terminal of an EV user (300 in FIG. 6). To this end, the mobile terminal 300 may connect to the parking system 200 using an application and then provide the information to the parking system 200.

FIG. 5 is a block diagram illustrating a configuration of the parking system 200 according to one embodiment of the present disclosure.

Referring to FIG. 5, the parking system 200 may include a communication unit 210, an input unit 220, one or more sensing units 230, an output unit 240, a storage unit 250, a transportation unit 260, and a control module 290. In the description of FIG. 5, a description overlapping with that described in FIG. 1 will be omitted.

The communication unit 210 may communicate with the charging robot 100 and a mobile terminal (for example, 300 in FIG. 6) corresponding to the EV. The mobile terminal is a mobile terminal of a user who operates the EV, and may receive charge status information, parking position information, and the like through the communication unit 210.

The input unit 220 is a module for inputting a user input or an image signal, and may receive, from the user, vehicle information, contact number information, desired charge cost information, desired amount-of-charge information, and the like of the user.

The storage unit 250 may store information on the EV charging waiting list. The EVs waiting for charging may be assigned a priority, and the control module 290 may cause the EVs waiting for charging to move to the charging housing area AA1 in order of priority.

The transportation unit 260 may drive the parking plate PS to move the EV to the charging housing area AA1 in which the charging robot 100 is disposed. The transportation unit 260 may include: the rotational movement unit 261 for rotating the parking plate PS; the vertical movement unit 263 for vertically raising and lowering the parking plate PS; and the horizontal movement unit 265 for moving the parking plate PS horizontally.

The control module 290 may cause the EV to move to a predetermined housing area depending on whether the charging housing area is available. For example, when the EV enters, the control module 290 may cause the EV to move to the charging housing area if the charging housing area is available. However, when the charging housing area is unavailable, the control module 290 may cause the EV to move to an area adjacent to the charging housing area, or may cause the EV to wait in a place other than the housing area based on the charge completion time of the EV currently being charged and based on whether a subsequent entering vehicle is present.

The control module 290 may determine that the entering vehicle is the EV to be charged by the charging robot 100, based on information sensed by the sensing unit or information inputted through the camera 221. This means that the entering vehicle is the EV to be charged by the user's intention.

The control module 290 may control the transportation unit 260 such that when the charging housing area AA1 is an available space (empty space), the EV to be charged moves to the charging housing area AA1. However, when the charge housing area AA1 is in use, the control module 290 may add the EV to be charged to the EV charging waiting list and then cause the EV to move to a housing area adjacent to the charging housing area AA1. The distance from the charging housing area AA1 to the housing area adjacent to the charging housing area AA1 may be determined depending on the waiting priority.

Then, when the EV of which charging is completed is moved to another housing area, the control module 290 may cause an EV having the highest priority among the EVs waiting for charging to move to the charging housing area AA1 for charging.

When the EV to be charged is moved to the charging housing area AA1, the control module 290 may control the transportation unit 260, particularly the rotational movement unit 261, such that the charging port of the EV to be charged is adjacent to the position of the charging robot 100. Accordingly, the control module 290 may cause the EV battery to be immediately charged as soon as the EV reaches the charging housing area AA1.

When the entering vehicle is not an EV, the control module 290 may control the transportation unit 260 such that the transportation unit 260 moves the entering vehicle to a housing area far away from the charge housing area AA1. When the entering vehicle is an EV but has no intention to charge, the control module 290 may also cause the entering vehicle to move to the housing area far away from the charge housing area AA1.

The control module 290 may transmit, to the charging robot 100 through the communication unit 210, the position information on the charging port of the EV to be charged, and may receive the desired amount-of-charge information through the input unit 220 and transmit the information to the charging robot 100.

In addition, when the charging is completed, the control module 290 may transmit a charge completion notification to a terminal corresponding to the EV of which charging is completed.

The above-mentioned parking system 200 may be applied not only to a parking tower but also to a single-level or multi-level parking space, and an underground parking lot.

FIG. 6 is a view illustrating a communication method between components according to one embodiment of the present disclosure.

Referring to FIG. 6, the parking system 200 may communicate with the charging robot 100 through the power line communication (PLC), which is a type of wired communication. The PLC may transmit voice data, text data, image data, and the like over power lines. According to an alternative embodiment, the parking system 200 may also communicate with the EV charging source 320 through the PLC.

In addition, the parking system 200 and the charging robot 100 may be equipped with a 5G communication module. Since the parking system 200 and the charging robot 100 may transmit data at speeds of 100 Mbps to 20 Gbps, they may transmit large volumes of moving images to the mobile terminal 300. Furthermore, the parking system 200 and the charging robot 100 may be driven with low power, thereby minimizing power consumption.

In addition, the parking system 200 and the charging robot 100 may support various object intelligent communications such as Internet of Things (IoT), Internet of Everything (IoE), and Internet of Small Things (IoST). Furthermore, the parking system 200 and the charging robot 100 may support Machine to Machine (M2M) communication, Vehicle to Everything (V2X) communication, Device to Device (D2D) communication and the like.

The parking system 200 may receive, from the mobile terminal 300 carried by the user USER, the desired amount-of-charging information on the EV, the information on the charging port of the EV, and the like. According to an alternative embodiment, the parking system 200 may receive the desired amount-of-charge information or the like through the user interface as described above.

In addition, the parking system 200 and the charging robot 100 may be equipped with a module relating to artificial intelligence (AI). Herein, artificial intelligence is an area of computer engineering science and information technology that studies methods to make computers mimic intelligent human behaviors such as reasoning, learning, self-improving, and the like.

In addition, artificial intelligence (AI) does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly-set static program commands, may be used to take an approach that builds models for deriving predictions and decisions from inputted data.

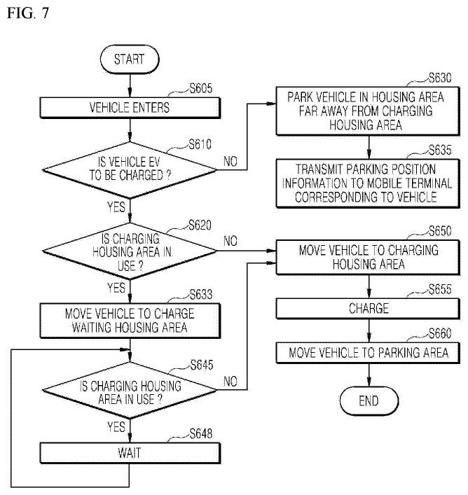

Hereinafter, a driving or a operating method of the parking system 200 for managing the parking tower PTO will be described with reference to FIG. 7.

First, when the vehicle enters the management range of the parking system 200 (S605), the parking system 200 determines whether the vehicle is an EV to be charged by the charging robot 100 (S610). That is, the parking system 200 may determine whether the vehicle is an EV to be charged.

When the vehicle is an EV but the user does not want to charge the vehicle, the parking system 200 may exclude the vehicle from being charged.

If the vehicle is not the EV to be charged (S610), the parking system 200 causes the vehicle to be parked in a housing area far away from the charging housing area (S630), and transmits the parking position information to the mobile terminal corresponding to the vehicle (S635).

That is, if the vehicle is not the EV to be charged (S610), the parking system 200 may set the charging priority of the vehicle to the lowest level.

If the vehicle is the EV to be charged (S610), the parking system 200 determines whether the charging housing area is in use (S620).

The parking system 200 may monitor whether charging of the EV currently being charged is completed. The parking system 200 may communicate with the charging robot 100 or the EV charging source 320 in order to monitor a charging status of the EV. When the charging is completed, the parking system 200 may cause the EV of which charging is completed to move to another housing area. Then, the parking system 200 may cause an EV having the highest priority among the EVs waiting for charging to move to the charging housing area for charging. To this end, the parking system 200 manages the EV charging waiting list, and may cause the EV having the highest priority for charging to be charged first.

If the charging housing area is in use (S620), the parking system 200 cause the vehicle to move to the charge waiting housing area (S630).

When the charging priority of the entering vehicle is the highest, the parking system 200 may cause the entering vehicle to move directly to the charging housing area. However, when the charging priority of another EV is higher, the parking system 200 may cause the entering vehicle to move to the charge waiting housing area.

According to an alternative embodiment, the parking system 200 may cause the fully charged EV to move to a predetermined housing area, and cause the EV disposed on the parking plate to move directly to the charging housing area.

The parking system 200 may determine whether to move the entering vehicle, based on estimated charge completion time information on the EV being charged and based on information on whether a subsequent vehicle entering the parking tower is present. In such a case, the EV moving directly to the charging housing area may wait at a predetermined place other than the housing area.

When the entering vehicle moves to the charging housing area, the parking system 200 may cause the parking plate to rotate so that the charging robot grasping the charging gun located at the EV charging source may easily move to the position of the charging port of the entering vehicle, and may cause the entering vehicle to be parked in the charging housing area by vertically raising the entering vehicle with the rotated parking plate. In step S645, if the charging housing area is available, the parking system 200 causes the vehicle to move to the charging housing area (S650). Then, the parking system 200 causes the EV to be charged (S655) and causes the EV to move to the parking area (S660).

Returning again to S620, if the charging housing area is unavailable (S620), the parking system 200 may cause the EV to wait in the charge waiting housing area or the current position (S648).

When there are a large number of EVs that are waiting for charging, the parking system 200 may cause the EVs to be sequentially charged based on the priority of the EVs on the EV charging waiting list.

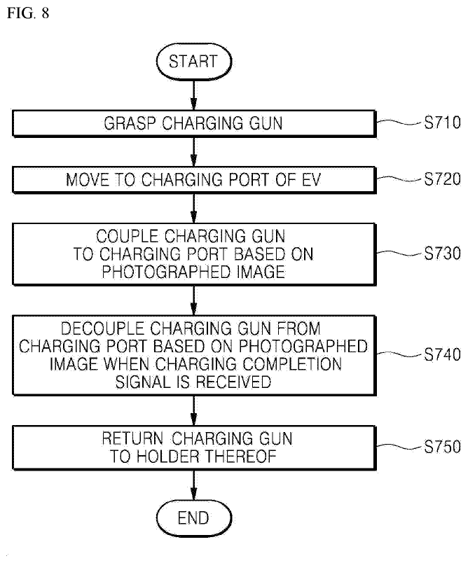

FIG. 8 illustrates a process in which the charging robot 100 performs charging, according to one embodiment of the present disclosure.

First, when the EV vehicle enters the charging housing area AA1, the charging robot 100 grasps the charging gun (S710). Depending on the embodiment, the charging robot 100 and the charging gun may also be implemented to be integrated with each other.

Then, the charging robot 100 moves to the charging port of the EV (S720). The charging robot 100 may receive the position information on the charging port of the EV from the parking system 200, and may recognize the charging port using the camera 121 mounted on the robot arm 170.

The charging robot 100 couples the charging gun to the charging port based on the photographed image (S730). The photographed image may be acquired through a vision camera capable of processing an image.

When the charge completion signal is received from the EV charging source, the charging robot 100 decouples the charging gun from the charging port based on the photographed image (S740).

During the charging or after completion of the charging, the charging gun may have a different form from that when the charging gun was initially coupled to the charging port. For example, the charging gun may move in the gravitational direction due to the cable. Thus, the charging robot 100 may decouple the charging gun from the charging port based on the image photographed through the vision camera.

Then, the charging robot 100 returns the charging gun to the holder thereof (S750).

The present disclosure described above may be embodied as computer-readable code on a computer-readable medium. The computer-readable medium includes any type of recording device capable of storing data which may be read by a computer system. Examples of the computer-readable medium may include a hard disk drive (HDD), a solid state disk (SSD), a silicon disk drive (SDD), a ROM, a RAM, a CD-ROM, a magnetic tape, a floppy disk, an optical data storage device, and the like. Further, the computer may include the control module 190 of the charging robot 100 or the control module 290 of the parking system 200.

Although specific embodiments of the present disclosure have been shown and described above, the present disclosure is not limited to the specific embodiments described, and those skilled in the art will appreciate that various modification and changes may be made therein, without departing from the scope and spirit of the present disclosure. Therefore, the scope of the present disclosure should not be limited by the embodiments described but should be determined by the technical idea described in the claims.

What is claimed is:

1. A charging robot that is disposed in a charging housing area in which an electric vehicle (EV) may be charged, the charging robot comprising:
a communicator configured to communicate with a parking system;
a robot arm configured to handle a charging gun connected to an EV charging source;
an inputter configured to input an image signal; and
a controller configured to recognize a charging port of the EV based on information inputted through the inputter, and to control the robot arm such that the robot arm couples the charging gun to the charging port or decouples the charging gun from the charging port,
wherein the controller is configured to cause the communicator to transmit charge completion information on the EV to the parking system when charging of the EV is completed.

2. The charging robot according to claim 1, wherein the controller is configured to cause the communicator to receive, from the parking system, position information on the charging port of the EV and desired amount-of-charge information on the EV, and to transmit charge state information on the EV to the parking system.

3. The charging robot according to claim 1, further comprising a mover, and
wherein the controller is configured to cause the mover to move, based on position information on the charging port of the EV, to a point in the charging housing area at which the mover may easily move to the position of the charging port of the EV, in a state in which the robot arm is grasping the charging gun.

4. A parking system having a charging housing area in which an electric vehicle (EV) may be charged, the parking system comprising:
a communicator configured to communicate with a charging robot located in the charging housing area;
an inputter configured to input a user input or an image signal;
one or more sensors;
a transporter configured to drive a parking plate to move the EV to an area in which the charging robot is disposed; and
a controller configured to determine, based on information sensed by the sensor or information inputted through the inputter, whether an entering vehicle is an EV to be charged,
wherein the controller is configured to cause the transporter to move the EV to be charged to the charging housing area when the entering vehicle is the EV to be charged and the charge housing area is available.

5. The parking system according to claim 4, wherein the transporter comprises:
a rotational mover configured to rotate the parking plate on which the EV is placed;
a vertical mover configured to move the parking plate vertically; and
a horizontal mover configured to move the parking plate horizontally, and
wherein the controller is configured to cause the transporter to rotate the EV to be charged using the rotational mover so that when the EV to be charged is moved to the charging housing area, a charging port of the EV to be charged is adjacent to the position of the charging robot grasping the charging gun.

6. The parking system according to claim 4, wherein the controller is configured to cause the transporter to move the entering vehicle to a housing area that is located at a predetermined distance from the charging housing area when the entering vehicle is not an EV.

7. The parking system according to claim 6, wherein when the entering vehicle is the EV to be charged but the charging housing area is in use, the controller is configured to cause the transporter to move the entering vehicle to a housing area adjacent to the charge housing area, and to add information on the entering vehicle to an EV charging waiting list.

8. The parking system according to claim 7, wherein the controller is configured to cause the transporter to move, to the charging housing area, an EV having a higher priority on the EV charging waiting list when the charging housing area becomes available.

9. The parking system according to claim 4, wherein the controller is configured to transmit, through the communicator, position information on a charging port of the EV to be charged and desired amount-of-charge information on the EV, to the charging robot.

10. The parking system according to claim 4, wherein the controller is configured to cause the communicator to transmit a charge completion notification to a terminal corresponding to the EV to be charged.

11. A operating method of a parking system having a charging housing area in which an electric vehicle (EV) may be charged, the operating method comprising:
when the vehicle enters, determining whether the entering vehicle is an EV to be charged;
checking whether the charging housing area is available when desired amount-of-charge information on the entering vehicle is inputted; and
moving the entering vehicle to the charging housing area using a rotatably and vertically drivable parking plate when the charging housing area is available.

12. The operating method according to claim 11, further comprising:
moving the entering vehicle to a predetermined housing area adjacent to the charging housing area when the charging housing area is in use; and
adding information on the entering vehicle to an EV charging waiting list.

13. The operating method according to claim 11, further comprising determining whether to move the entering vehicle, based on estimated charge completion time information on the EV being charged and based on information on whether a subsequent entering vehicle is present, when the charging housing area is in use.

14. The operating method according to claim 12, further comprising moving, to the charging housing area, an EV having a higher priority on the EV charging waiting list, when the charging housing area becomes available.

15. The operating method according to claim 11, wherein the moving the entering vehicle to the charging housing area using the parking plate comprises:
rotating the parking plate so that the charging robot grasping the charging gun located at the EV charging source may easily move to the position of a charging port of the entering vehicle; and
vertically raising the entering vehicle with the rotated parking plate so as to park the entering vehicle in the charging housing area.
